(19) United States
(12) Patent Application Publication
(10) Pub. No.: US 2008/0175974 A1
(43) Pub. Date: Jul. 24, 2008

(54) Isomaltulose as an Aftertaste-Shortening Agent

(75) Inventors: Margit Arenz, Nehren (DE); Stephan Hausmanns, Wiesbaden (DE); Joerg Kowalczyk, Eisenberg/Steinborn (DE)

Correspondence Address: DARBY & DARBY P.C., P.O. BOX 770, Church Street Station, New York, NY, 10008-0770, US

(73) Assignee: Suedzucker Aktiengesellschaft Mannheim/Ochsenfurt, Mannheim (DE)

(21) Appl. No.: 11/914,440

(22) PCT Filed: Dec. 24, 2005
(86) PCT No.: PCT/EP05/14026

§ 371 Date: Jan. 25, 2008

(30) Foreign Application Priority Data
May 27, 2005 (DE) 10 2005 025 895.6

(51) Int. Cl. A23L 1/236; A23G 3/36; A23L 2/60

(52) U.S. Cl. 426/590; 426/658

(57) ABSTRACT

The present invention relates to the use of isomaltulose as a taste-decreasing (e.g., aftertaste-reducing) agent, and to sweetener mixtures in which isomaltulose decreases the duration of taste by, for example, reducing the duration of aftertaste.

This application is a U.S. National Phase Application under 35 U.S.C. §371 of International Patent Application No. PCT/EP2005/014026 filed Dec. 24, 2005, and claims the benefit of German Patent Application No. DE 2005 025 895 filed May 27, 2005, both of which are hereby incorporated by reference in their entireties. The International Application was published in German on Dec. 7, 2006 as WO 2006/128493.

### FIELD OF THE INVENTION

The present invention relates to mixtures of sweeteners comprising isomaltulose and at least one intense sweetener, in which the duration of the taste of at least one intense sweetener is decreased by isomaltulose, and the use of isomaltulose as a taste-decreasing (e.g., aftertaste-reducing) agent.

### BACKGROUND OF THE INVENTION

Intense sweeteners are frequently used as ingredients in beverages and in foods, semi-luxury foods, or medicines. However, intense sweeteners frequently have an undesirably long-lingering aftertaste.

One intense sweetener, approved for use in the U.S. in 1989 and in the European Union in 2004, which is frequently used to sweeten beverages and foods, semi-luxury foods and medicines, is sucralose.

Sucralose, which is also known to those of ordinary skill in the art as Splenda®, is the common name for 1,6-dichloro-1,6-didesoxy-β-D-fructofuranosyl-4-chloro-4-desoxy-α-D-galactopyranoside. Sucralose, described in British patent No. 1543167, is not metabolized in the body, has no calories, and can be used in dental care products. Sucralose is a highly intense sweetener. In aqueous solution, sucralose is approximately 600 times sweeter than sugar and possesses a clean taste profile. Sucralose has a distinct lingering aftertaste. Consumers consider this undesirable in many products, such as cola, lemonades and sweetened waters.

The reducing disaccharide ketose isomaltulose (6-O-α-D-glucopyranosyl-fructose), which occurs naturally, for example in honey, and which is also known to those of ordinary skill in the art as Palatinose, is used primarily as a source material for producing isomalt, a nearly equimolar mixture of the diastereomers 6-O-α-D-glucopyranosyl-D-sorbitol (1,6-GPS) and 1-O-α-D-glucopyranosyl-D-mannitol (1,1-GPM). Due to its low sweetening power and the resulting flavor, isomaltulose is used primarily in combination with sugar substitutes and/or sweeteners as a sweetening agent in foods. Due to the delayed degradation of the isomaltulose, which begins only when it reaches the small intestine, it is also used in special foods for athletes, to sustain their oxidative metabolism.

Isomaltulose crystallizes in the form of a monohydrate. The aqueous solubility of isomaltulose is 0.49 g anhydrous isomaltulose per gram of water. Isomaltulose has advantageous acariogenic properties, because it is not degraded by the bacteria in the human mouth. Isomaltulose is broken down only in a delayed fashion by the glucosidases in the wall of the human small intestine, with the resulting decomposition products glucose and fructose being resorbed. This results in a slow increase in blood glucose, as compared with rapidly digestible carbohydrates. Isomaltulose requires hardly any insulin for metabolization, in contrast to rapidly digestible, high-glycemic foods. Despite its favorable acariogenic properties, isomaltulose has rarely been used as the sole sugar or sole sweetening agent in foods or beverages, unlike sugar substitutes such as mannitol, sorbitol and isomalt, or sweeteners like cyclamate. This is due especially to the taste of isomaltulose, especially due to its substantially lower sweetening power as compared with saccharose. The sweetening power of 10% aqueous isomaltulose solutions amounts to only approximately 0.4 of the sweetening power of sugar.

To some extent, isomaltulose is also used to mask the unpleasant taste of other foods. EP 0 809 939 A1 describes a yogurt containing lactic-acid bacteria and bifido bacteria, which contains refined fish oil with a high ratio of unsaturated fatty acids, and a sweetening agent, such as isomaltulose. Isomaltulose is added to prevent the development of the typical fish taste and fish odor. JP 63152950 A2 describes the production of vegetable gelatin products using various types of vegetables and a gelling agent, in which isomaltulose and other additives such as cinnamon are used to mask the unpleasant odor of some vegetable components.

DE 690 005 48 T2 describes sweetener compositions containing sucralose and isomaltulose, wherein these compositions have a synergistic effect, in other words they exhibit greater sweetening power together than what would be the expected sweetening power demonstrated by the sweetening components if added alone. The mixture of sweeteners can be used, for example, in the production of beverages and confections.

U.S. Pat. No. 5,902,628 describes the decrease in the lingering, sweet aftertaste of sucralose by mixing it with tannic acids.

However, tannic acids, such as tannins, can have a bitter taste, which can be unpleasant in beverages and foods, semi-luxury foods or medicines.

### BRIEF DESCRIPTION OF THE DRAWINGS

FIG. 1 is a graphic representation of the sensory evaluation of milk chocolate containing sucralose.

FIG. 2 a graphic representation of the sensory evaluation of solutions containing saccharose.

### DETAILED DESCRIPTION OF THE INVENTION

The present invention is based upon the technical problem of creating beverages, foods, semi-luxury foods or medicines in which the lingering aftertaste of intense sweeteners, especially sucralose, is shortened, without this affecting the taste quality in a way that is unpleasant or strange to consumers. Furthermore, the intention is not to decrease the sweetening power or sweetness intensity of sucralose and/or the sweetening agents in the relevant product, but only to decrease the duration of the sweet aftertaste.

The present invention is further based upon the technical problem of providing methods and products, especially sweetener mixtures, with which the duration of lingering aftertaste of intense sweeteners, especially sucralose, is decreased in foods, semi-luxury foods or medicines, and beverages in the aforementioned manner.

The present invention solves the technical problem upon which it is based through the use of isomaltulose as a taste-decreasing (e.g., aftertaste-reducing) agent, preferably through the use of isomaltulose to decrease the taste duration of at least one intense sweetener, especially sucralose, i.e., 1,6-dich loro-1,6-didesoxy-β-D-fructofuranosyl-4-chloro-4-desoxy-α-D-galactopyranoside.

In the context of the invention, “taste” is understood to mean the chemical sense of humans to perceive and differentiate foods. Humans are able to differentiate essentially four taste qualities: sweet, sour, bitter, and salty. The taste stimulus occurs as a result of the activation of a gustatory cell by the deposition of molecules of a taste substance on receptor molecules. A taste stimulus can be pronounced to different degrees in terms of its quality, for example whether it is sweet, sour, bitter, salty, or a mixture of these, in its intensity, in other words the strength of the taste, and in its duration. No connection between taste intensity and taste duration necessarily exists. A decrease in taste intensity, for example sweetening power, does not necessarily mean a simultaneous reduction in taste duration, and vice versa. A reduction in taste duration does not necessarily mean a change, especially a decrease, in taste intensity.

One component of taste duration is the duration of the aftertaste, in other words the taste that lingers or persists after a product has been consumed, or the final taste phase. In some cases, aftertaste can linger a long time.

Preferably, when isomaltulose is used as a taste-decreasing agent, the duration of the lingering, especially persistent, aftertaste of an intense sweetener is decreased, without its taste intensity, in other words its sweetening power, or its other flavor qualities being thereby altered, especially decreased or intensified. Preferably, isomaltulose decreases the duration of the taste, especially the aftertaste, of an intense sweetener through an effect that is independent of the solubility of the sweetening agents, in other words isomaltulose does not alter the solubility of sucralose or other intense sweeteners. Most preferably, isomaltulose decreases only the aftertaste of an intense sweetener, especially sucralose, in other words in the final taste phase, without shortening the main phase, in other words the taste during consumption. The initial taste sensation is also preferably unaffected.

In the context of the present invention, the term “sweetening agent” is used to refer to substances that have sweetening power and are added, for example, to foods or beverages in order to give them a sweet taste. In the context of the present invention “sweetening agents” are subdivided into “sugars” such as isomaltulose, saccharose, glucose or fructose, which provide body and sweetening power, and “sweeteners”, in other words substances that are not sugars but nevertheless have sweetening power, which are in turn subdivided into “sugar substitutes”, in other words sweetening agents that have body and a physiological calorific value in addition to a sweetening power (sweeteners absorbed by the body), and “intense sweeteners”, in other words substances that ordinarily have a very high sweetening power, but no body and ordinarily no, or only a low, physiological calorific value. Sucralose is an example of an intense sweetener.

The invention relates to the use of isomaltulose as a taste-decreasing agent. According to the invention, the use of isomaltulose is preferred, wherein the isomaltulose decreases the duration of the taste of at least one intense sweetener, especially sucralose.

According to the invention, isomaltulose is preferably used to decrease the duration of an aftertaste or the lingering aftertaste, especially a sweet aftertaste or lingering sweet aftertaste, of at least one intense sweetener, especially sucralose.

Preferred according to the invention is the use of isomaltulose as specified in the invention in a mixture of sweeteners, preferably a mixture of sweeteners containing isomaltulose and at least one intense sweetener, especially sucralose. Especially preferably, the mixture of sweeteners is comprised of only isomaltulose and sucralose; optionally, however, additional components may also be included, for example additional sweetening agents. Preferably, however, the mixture of sweetening agents does not contain glucose, fructose and/or saccharose.

Preferred according to the invention is the use of isomaltulose as specified in the invention in a mixture of sweeteners, wherein the mixture of sweeteners contains 1 to 99 percent by weight, especially 40 to 99 percent by weight, preferably 70 to 98 percent by weight, more preferably 80 to 95 percent by weight isomaltulose (based on the total dry substance weight of the mixture of sweeteners).

Preferred according to the invention is the use of isomaltulose as specified in the invention, especially in the aforementioned quantities, in a mixture of sweeteners, wherein the mixture of sweeteners contains 0.0005 to 3 percent by weight, especially 0.001 to 1 percent by weight, preferably 0.01 to 0.5 percent by weight, more preferably 0.02 to 0.1 percent by weight intense sweetener (based on the total dry substance weight of the mixture of sweeteners).

Preferred according to the invention is the use of isomaltulose as specified in the invention in a food, semi-luxury food, or medicine or in a beverage. Also preferred according to the invention is the use of the mixture of sweeteners of the invention in a food, semi-luxury food, or medicine or in a beverage.

Preferred according to the invention is the use of isomaltulose as specified in the invention in a dietetic food. Also preferred according to the invention is the use of the mixture of sweeteners specified in the invention in a dietetic food.

Preferred according to the invention is the use of the mixture of sweeteners specified in the invention in a beverage, food, semi-luxury food or medicine, wherein the beverage, food, semi-luxury food or medicine contains 1 to 99 percent by weight, especially 20 to 70 percent by weight, preferably 30 to 60 percent by weight, more preferably 40 to 55 percent by weight of the mixture of sweeteners (based on the total dry substance weight of the beverage, food, semi-luxury food or medicine). In a particular embodiment, the beverage, food, semi-luxury food or medicine does not contain glucose, fructose and/or saccharose. According to the invention, however, another embodiment may contain glucose, fructose, saccharose and/or other sweetening agents.

The invention also relates to a mixture of sweeteners containing isomaltulose and at least one intense sweetener, preferably sucralose, wherein the duration of taste of the at least one intense sweetener, preferably sucralose, is altered, preferably decreased, by the isomaltulose. The invention also relates to a mixture of sweeteners containing isomaltulose and at least one intense sweetener, preferably sucralose, wherein the duration of the lingering, preferably sweet, aftertaste of the at least one intense sweetener, preferably sucralose, is altered, preferably decreased, by the isomaltulose. The invention also relates to a mixture of sweeteners containing isomaltulose and sucralose, wherein the duration of taste of an intense sweetener, preferably sucralose, is altered, preferably decreased, by the isomaltulose.

Preferred according to the invention is a mixture of sweeteners as specified in the invention that contains 1 to 99 percent by weight, especially 40 to 99 percent by weight, preferably 70 to 98 percent by weight, more preferably 80 to 95 percent by weight isomaltulose (based on the total dry substance weight of the mixture of sweeteners).

Preferred according to the invention is a mixture of sweeteners as specified in the invention that contains 0.0005 to 3 percent by weight, especially 0.001 to 1 percent by weight, preferably 0.01 to 0.5 percent by weight, more preferably 0.02 to 0.1 percent by weight intense sweetener (based on the total dry substance weight of the mixture of sweeteners).

The invention also relates to beverages, foods, semi-luxury foods or medicines in which isomaltulose is used in accordance with the invention. The invention also relates to dietetic foods in which isomaltulose is used in accordance with the invention.

The invention also relates to beverages, foods, semi-luxury foods or medicines in which the duration of the taste, especially the lingering, preferably sweet, aftertaste of at least one intense sweetener, preferably sucralose, is decreased with isomaltulose.

The aforementioned beverages include, for example, non-alcoholic beverages, refreshment beverages, cola-containing beverages, sports drinks, beverage ingredients, and drink powders.

In the context of the present invention, the term “foods” refers to products or substance mixtures in solid, liquid, dissolved or suspended form that are used predominantly to nourish humans and are consumed by humans in an unaltered, prepared or processed form. Foods may contain other components in addition to their natural constituents, which may be of natural or synthetic origin. Foods may be in solid form or in liquid form. The term “semi-luxury foods” refers predominantly to substances or mixtures of substances, in solid, liquid, dissolved or suspended form, that provide enjoyment to the human or animal body when consumed.

In the preferred embodiment of the invention, the foods mentioned in the invention refer to milk or milk products, such as cheese, butter, yogurt, kefir, quark, sour milk, buttermilk, cream, condensed milk, freeze-dried milk, whey, milk mixtures, milk half-fat, whey mixture products, milk sugar, milk protein and milk fat products. In a further preferred embodiment of the invention, the foods mentioned in the invention refer to baked goods, especially breads including cookies and cakes, and including preserved baked goods. In further embodiments of the invention, the foods mentioned in the invention refer to bread spreads, margarine products and shortening, as well as instant products and broths. In further preferred embodiments of the invention, the foods mentioned in the invention refer to fruit products, especially jams, marmalades, jellies, canned fruits, fruit pulp, fruit juices, fruit juice concentrates, fruit nectar, and powdered fruit. The foods containing the products according to the invention can also be vegetable products, especially canned vegetables, vegetable juices and vegetable pulp, according to the invention.

The term semi-luxury foods refers, for example, to confections, especially chocolate products, hard caramels, soft caramels, fondant products, gelled products, licorice, whipped sugar products, flaked coconut, dragees, condensed foods, candied fruits, brittle, nougat products, frozen confections, marzipan, chewing gum, granola bars, and ice creams, or alcoholic or non-alcoholic sweetened drinks.

In the context of the present invention, “dietetic foods” are understood as foods that are intended to serve a specific nutritional purpose, in that they effect the supply of certain nutrients or other nutritional substances that produce a physiological effect in a certain proportion or in a certain condition. Dietetic foods differ substantially from foods of a comparable type in their composition or in their properties. Dietetic foods can be used in all cases in which certain nutritional requirements must be fulfilled due to illnesses, functional disorders or allergic reactions to specific foods or their ingredients. Dietetic foods can be in solid or liquid form.

According to the invention, a beverage, food, semi-luxury food or medicine as specified in the invention preferably contains 1 to 99 percent by weight, especially 20 to 70 percent by weight, preferably 30 to 60 percent by weight, more preferably 40 to 55 percent by weight of the mixture of sweeteners of the invention (based on the total dry substance weight of the beverage, food, semi-luxury food or medicine).

The invention also relates to a method for decreasing the taste duration of at least one intense sweetener, preferably sucralose, wherein isomaltulose is added to the at least one intense sweetener.

Preferred according to the invention is a method for decreasing the duration of the lingering, preferably sweet aftertaste of at least one intense sweetener, preferably sucralose, wherein isomaltulose is added to the at least one intense sweetener.

The invention also relates to a mixture of isomaltulose and an intense sweetener, preferably sucralose, obtainable, especially obtained, via a method according to the invention.

Additional embodiments of the invention are described in the claims.

### EXAMPLES

The invention will be described in greater detail in the context of the following exemplary embodiments and the associated figures. The use of these and other examples anywhere in the specification is illustrative only, and in no way limits the scope and meaning of the invention or of any exemplified form. Likewise, the invention is not limited to any particular preferred embodiments described herein. Indeed, modifications and variations of the invention may be apparent to those skilled in the art upon reading this specification, and can be made without departing from its spirit and scope. The invention is therefore to be limited only by the terms of the claims, along with the full scope of equivalents to which the claims are entitled.

### Example 1

Milk chocolates containing sucralose were produced, which contained either a sugar substitute or isomaltulose (Palatinose™) as the sweetener that is absorbed by the body. These milk chocolates were evaluated sensorially with respect to their aftertaste that is typical of sucralose.

Layout of sample form:

Sensory Evaluation of Chocolate

| | |
|---|---|
| Name: | Date: |

“You have before you samples of chocolate containing sucralose. Sucralose has a pronounced, lingering aftertaste. The following samples are to be evaluated with regard to whether, and if so to what extent, this aftertaste is perceptible.

Please take a serving of chocolate (1 “square”) and suck on it. Please do not chew and swallow the sample, as this will not allow the taste to develop fully. Then please assess the aftertaste of the sample.

To neutralize the taste, please have some of the prepared tea and the white bread.”

Aftertaste

| | | | | |
|---|---|---|---|---|
| | 0 | 1 | 2 | |
| Sample | None | Slight | Definite | Remarks |

003-01
004-01
005-01

Samples:
Milk chocolate containing sucralose with isomaltulose
Milk chocolate containing sucralose with trehalose
Milk chocolate containing sucralose with lactite
Milk chocolate containing sucralose with maltite
Milk chocolate containing sucralose with erythrite

Isomaltulose milk chocolate

| Ingredients | Ratio g/100 g |
|---|---|
| Isomaltulose | 42.41 |
| Cocoa solids | 13.01 |
| Whole milk powder | 21.02 |
| Cocoa butter | 20.02 |
| Hazelnut paste | 3.00 |
| Lecithin | 0.50 |
| Vanilla flavoring | 0.02 |
| Sucralose | 0.02 |

Trehalulose milk chocolate

| Ingredients | Ratio g/100 g |
|---|---|
| Trehalose | 42.41 |
| Cocoa solids | 13.01 |
| Whole milk powder | 21.02 |
| Cocoa butter | 20.02 |
| Hazelnut paste | 3.00 |
| Lecithin | 0.50 |
| Vanilla flavoring | 0.02 |
| Sucralose | 0.02 |

Lactite milk chocolate

| Ingredients | Ratio g/100 g |
|---|---|
| Lactite | 42.405 |
| Cocoa solids | 13.01 |
| Whole milk powder | 21.02 |
| Cocoa butter | 20.02 |
| Hazelnut paste | 3.00 |
| Lecithin | 0.50 |
| Vanilla flavoring | 0.02 |
| Sucralose | 0.025 |

Maltite milk chocolate

| Ingredients | Ratio g/100 g |
|---|---|
| Maltite | 42.413 |
| Cocoa solids | 13.01 |
| Whole milk powder | 21.02 |
| Cocoa butter | 20.02 |
| Hazelnut paste | 3.00 |
| Lecithin | 0.50 |
| Vanilla flavoring | 0.02 |
| Sucralose | 0.017 |

Erythrite milk chocolate

| Ingredients | Ratio g/100 g |
|---|---|
| Erythrite | 42.411 |
| Cocoa solids | 13.01 |
| Whole milk powder | 21.02 |
| Cocoa butter | 20.02 |
| Hazelnut paste | 3.00 |
| Lecithin | 0.50 |
| Vanilla flavoring | 0.02 |
| Sucralose | 0.019 |

The sensory evaluation of the chocolates containing sucralose was performed by 12 to 17 test subjects.

The aftertaste of the sucralose was assessed after the chocolate had been completely dissolved in the mouth.

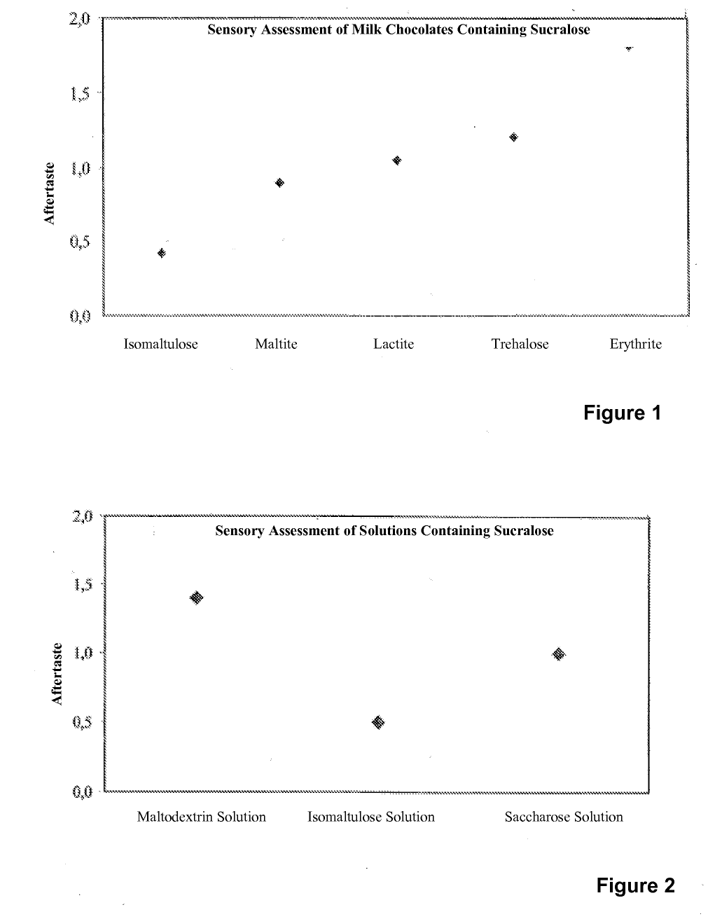

Result: In milk chocolates containing sucralose, isomaltulose decreases the lingering aftertaste of this sweetener, as is shown in FIG. 1. This is clearly noticeable when compared with milk chocolates containing sucralose along with other sugar substitutes, especially erythrite, for example.

### Example 2

Aqueous solutions containing sucralose were prepared, which contained isomaltulose, maltodextrin or saccharose as a sweetener. All the solutions also contained sucralose. The solutions were sensorially evaluated with respect to their aftertaste that is typical of sucralose, wherein the sample form the test subjects used was the same as the sample form described in Example 1.

Samples:
Maltodextrin solution: 7.916% maltodextrin; 0.004% sucralose; 92.080% water
Palatinose™ solution: 7.916% isomaltulose; 0.004% sucralose; 92.080% water
Saccharose solution: 5.603% saccharose; 0.004% sucralose; 94.393% water

The sensory evaluation of the solutions containing sucralose was performed by 5 test subjects.

The aftertaste of the sucralose was assessed immediately following consumption of the solution containing sucralose.

Result: In solutions containing sucralose, isomaltulose decreases the lingering aftertaste of this sweetener as compared with solutions containing maltodextrin or saccharose (0=no perceptible aftertaste; 2=aftertaste clearly perceptible).

All references cited and/or discussed in this specification are incorporated herein by reference in their entirety and to the same extent as if each reference was individually incorporated by reference.

1-11. (canceled)

12. A method of decreasing the duration of the taste of an intense sweetener in a product, comprising including isomaltulose in the product.

13. The method of claim 12, wherein the intense sweetener is sucralose.

14. The method of claim 13, wherein the isomaltulose decreases the duration of a lingering aftertaste of the sucralose.

15. The method of claim 14, wherein the lingering aftertaste of the sucralose is a sweet aftertaste.

16. A method of decreasing the duration of the taste of an intense sweetener in a mixture of sweeteners, comprising including isomaltulose in the mixture of sweeteners.

17. The method of claim 16, wherein the mixture of sweeteners is present in a food, semi-luxury food, medicine, or beverage.

18. The method of claim 17, wherein the mixture of sweeteners is present in a dietetic food.

19. The method of claim 16, wherein the mixture of sweeteners comprises 1 to 99 percent by weight isomaltulose based on the total dry substance weight of the mixture of sweeteners.

20. The method of claim 19, wherein the mixture of sweeteners comprises 40 to 99 percent by weight isomaltulose based on the total dry substance weight of the mixture of sweeteners.

21. The method of claim 20, wherein the mixture of sweeteners comprises 70 to 98 percent by weight isomaltulose based on the total dry substance weight of the mixture of sweeteners.

22. The method of claim 16, wherein the mixture of sweeteners comprises 0.0005 to 3 percent by weight sucralose based on the total dry substance weight of the mixture of sweeteners.

23. The method of claim 22, wherein the mixture of sweeteners comprises 0.001 to 1 percent by weight sucralose based on the total dry substance weight of the mixture of sweeteners.

24. The method of claim 23, wherein the mixture of sweeteners comprises 0.01 to 0.5 percent by weight sucralose based on the total dry substance weight of the mixture of sweeteners.

25. The method of claim 17, wherein the food, semi-luxury food, medicine, or beverage comprises 1 to 99 percent by weight of the mixture of sweeteners based on the total dry substance weight of the food, semi-luxury food, medicine, or beverage.

26. The method of claim 25, wherein the food, semi-luxury food, medicine, or beverage comprises 20 to 70 percent by weight of the mixture of sweeteners based on the total dry substance weight of the food, semi-luxury food, medicine, or beverage.

27. The method of claim 26, wherein the food, semi-luxury food, medicine, or beverage comprises 30 to 60 percent by weight of the mixture of sweeteners based on the total dry substance weight of the food, semi-luxury food, medicine, or beverage.

28. A mixture of sweeteners, comprising 1 to 99 percent by weight isomaltulose and 0.0005 to 3 percent by weight sucralose.

29. The mixture of claim 28, comprising 80 to 95 percent by weight isomaltulose and 0.02 to 0.1 percent by weight sucralose.

30. A food, semi-luxury food, medicine, or beverage, comprising 1 to 99 percent by weight of a mixture of sweeteners comprising isomaltulose and at least one intense sweetener.

31. The food, semi-luxury food, medicine, or beverage of claim 30, comprising 40 to 55 percent by weight of a mixture of sweeteners comprising isomaltulose and at least one intense sweetener.
